(19) United States
(12) Patent Application Publication
(10) Pub. No.: US 2020/0142290 A1
(43) Pub. Date: May 7, 2020

(54) COMPOSITE PHASE CONVERSION ELEMENT AND PROJECTION APPARATUS

(71) Applicant: Coretronic Corporation, Hsin-Chu (TW)

(72) Inventors: Yao-Shun Lin, Hsin-Chu (TW); Chi-Tang Hsieh, Hsin-Chu (TW); Chih-Hsien Tsai, Hsin-Chu (TW); Haw-Woei Pan, Hsin-Chu (TW)

(73) Assignee: Coretronic Corporation, Hsin-Chu (TW)

(21) Appl. No.: 16/667,908

(22) Filed: Oct. 30, 2019

(30) Foreign Application Priority Data
Nov. 2, 2018 (CN) 201811299218.6

(51) Int. Cl. G03B 21/20; G03B 21/28; G02B 5/30; G03B 21/00

(52) U.S. Cl. CPC G03B 21/2073; G03B 21/2033; G03B 21/006; G02B 5/3025; G03B 21/28

(57) ABSTRACT

A composite phase conversion element and a projection apparatus are provided. The composite phase conversion element is disposed on a transmission path of at least one beam, and includes at least one polarizing element, and the polarizing element includes multiple polarizing regions, where at least two of the polarizing regions have different polarization directions, the at least one beam simultaneously penetrates through at least two of the polarizing regions of the at least one polarizing element to respectively form at least two sub-beams, and polarization states of the two sub-beams correspond to the polarization directions of the at least two of the polarizing regions penetrated by the at least two sub-beams. Therefore, in a polarized 3D mode of the projection apparatus using the composite phase conversion element, color and brightness of a display image are uniform, and a user observes a 3D display image with good uniformity.

### CROSS-REFERENCE TO RELATED APPLICATION

This application claims the priority benefit of China application serial no. 201811299218.6, filed on Nov. 2, 2018. The entirety of the above-mentioned patent application is hereby incorporated by reference herein and made a part of this specification.

### BACKGROUND

### Technical Field

The invention relates to an optical element and an optical apparatus, and particularly relates to a composite phase conversion element and a projection apparatus.

### Description of Related Art

Projection apparatus is s display device adapted to produce large-size images, and along with evolution and innovation of technology, the projection apparatus has been continuously improved. An imaging principle of the projection apparatus is to convert an illumination beam generated by an illumination system into an image beam by using a light valve, and then project the image beam onto a projection target (for example, a screen or a wall) through a projection lens, so as to form a projection image.

Moreover, the illumination system has also evolved all the way from the Ultra-high-Performance (UHP) lamp, the Light-Emitting Diode (LED) to the most advanced Laser Diode (LD) light source along with the market requirements on brightness, color saturation, service life, non-toxicity and environmental protection of the projection apparatus. However, in the illumination system, a current cost effective method for producing red and green light is to use a blue laser diode to emit an excitation beam to a phosphor color wheel, and use the excitation beam to excite phosphor powder of the phosphor color wheel to produce yellow green light. Then, a filter wheel is adopted to produce the required red light and the green light for usage.

However, in the structure of the known illumination system, polarization polarity of the excitation beam entering the projection apparatus may be spoiled by optical devices in the projection apparatus, such that a polarization direction and an intensity of a light beam projected out of the projection apparatus become messy, which causes a problem of nonuniform brightness of a display image. Therefore, when the projection apparatus produces a 3D display image in a polarization 3D (three-dimensional) mode (a polarizer is externally added to the projection lens), an image projected out of the projection lens and the polarizer may have a phenomenon of nonuniform color or nonuniform brightness.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY

The invention is directed to a composite phase conversion element and a projection apparatus, where a color or brightness of a display image is uniform in a polarization 3D mode of the projection apparatus, so that a user observes the 3D display image with better uniformity.

Other objects and advantages of the invention may be further illustrated by the technical features broadly embodied and described as follows.

In order to achieve one or a portion of or all of the objects or other objects, an embodiment of the invention provides a composite phase conversion element disposed on a transmission path of at least one beam. The composite phase conversion element includes at least one polarizing element including a plurality of polarizing regions on a same plane, where at least two of the polarizing regions have different polarization directions, the at least one beam simultaneously penetrates through at least two of the polarizing regions of the at least one polarizing element to respectively form at least two sub-beams, and polarization states of the at least two sub-beams correspond to the polarization directions of the at least two of the polarizing regions penetrated by the at least two sub-beams.

In order to achieve one or a portion of or all of the objects or other objects, an embodiment of the invention provides a projection apparatus including an illumination system, at least one light valve and a lens. The illumination system is adapted to provide an illumination beam. The illumination system includes at least one excitation light source and a composite phase conversion element, and the at least one excitation light source is adapted to provide at least one excitation beam. The composite phase conversion element is disposed on a transmission path of the at least one excitation beam. The composite phase conversion element includes at least one polarizing element, and the at least one polarizing element includes a plurality of polarizing regions on a same plane, where at least two of the polarizing regions have different polarization directions, the at least one beam simultaneously penetrates through at least two of the polarizing regions of the at least one polarizing element to respectively form at least two sub-beams, and polarization states of the at least two sub-beams correspond to the polarization directions of the at least two of the polarizing regions penetrated by the at least two sub-beams. The illumination beam includes the at least two sub-beams. The at least one light valve is disposed on a transmission path of the illumination beam, and is adapted to convert the illumination beam into an image beam. The lens is disposed on a transmission path of the image beam, and is adapted to convert the image beam into a projection beam.

Based on the above description, the embodiments of the invention have at least one of following advantages or effects. In the composite phase conversion element of the invention or the projection apparatus configured with the composite phase conversion element, the polarizing element includes a plurality of polarizing regions on the same plane, and at least two of the polarizing regions have different polarizing directions. Therefore, the beam may penetrate through the polarizing element, and the beam penetrating through the polarizing element has different polarization states at different positions. In this way, in the polarization 3D mode of the projection apparatus (i.e. the polarizer is externally added to the projection lens), the color or the brightness of the display image may be uniform, so that the user may observe the 3D display image with better uniformity through a pair of polarized 3D glasses.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a projection apparatus according to an embodiment of the invention.

FIG. 2 is a schematic diagram of a composite phase conversion element of FIG. 1.

FIG. 3 is a schematic diagram of a composite phase conversion element according to another embodiment of the invention.

FIG. 4 is a schematic diagram of a composite phase conversion element according to still another embodiment of the invention.

FIG. 5 is a schematic diagram of a projection apparatus according to another embodiment of the invention.

FIG. 6 is a schematic diagram of a composite phase conversion element of FIG. 5.

FIG. 7 is a schematic diagram of a projection apparatus according to another embodiment of the invention.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

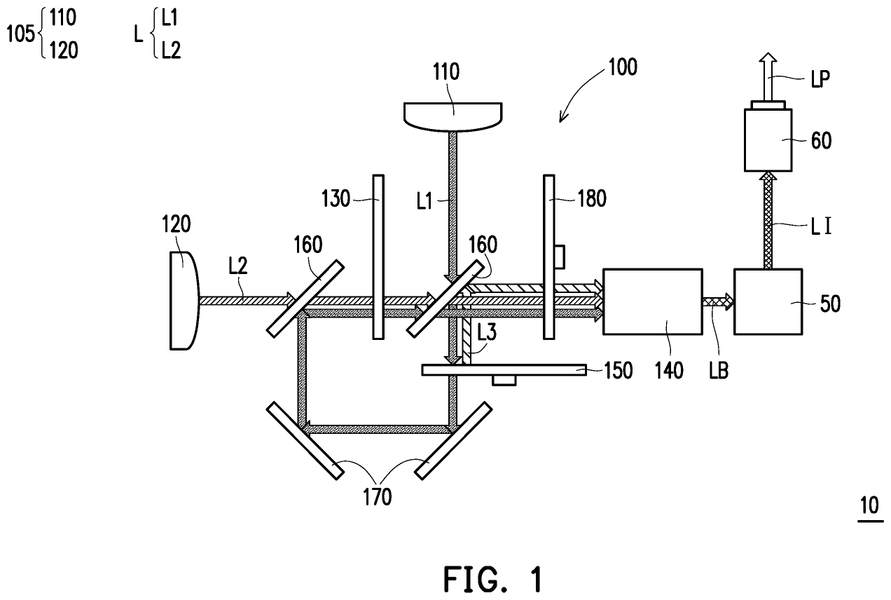

FIG. 1 is a schematic diagram of a projection apparatus according to an embodiment of the invention. Referring to FIG. 1, in the embodiment, the projection apparatus 10 is used for providing a projection beam LP. To be specific, the projection apparatus 10 includes an illumination system 100, at least one light valve 50 and a projection lens 60. The illumination system 100 is adapted to provide an illumination beam LB. The light valve 50 is disposed on a transmission path of the illumination beam LB, and is adapted to convert the illumination beam LB into at least one image beam LI. The so-called illumination beam LB refers to a beam provided to the light valve 50 by the illumination system 100 at any time. The projection lens 60 is disposed on a transmission path of the image beam LI, and is adapted to convert the image beam LI into a projection beam LP, and the projection beam LP is projected to a projection target (not shown), for example, a screen or a wall from the projection apparatus 10.

In application of a 3D display technique, the projection apparatus 10 of the embodiment may be used as a polarized 3D image projector. To be specific, when two projection apparatuses 10 are in a polarization 3D mode (i.e. polarizers of different polarization directions are externally added to the projection lenses 60 of the two projection apparatuses 10, or the polarizers of different polarization directions are built in the two projection apparatuses 10), the projection beams LP provided by the two projection apparatuses 10 may respectively pass through the corresponding polarizers, and images generated from the two projection apparatuses 10 have different polarization states, such that a user may observe a 3D display image through a pair of polarized 3D glasses, for example, the 3D glasses worn by the user are respectively configured with two polarizing elements used for a left eye lens and a right eye lens, and the two polarizing elements correspond to the image frames of different polarization states generated by the two polarizers of the two projection apparatuses, so that the left eye and the right eye of the user respectively receive the image frames projected by the corresponding projectors, so as to achieve the 3D display effect.

In detail, in the embodiment, the light valve 50 is, for example, a reflective light modulator, such as a Liquid Crystal on Silicon (LCoS) panel, a Digital Micro-mirror Device (DMD), etc. in some embodiments, the light valve 50 may also be a transmissive light modulator such as a transparent liquid crystal panel, an electro-optical modulator, a magneto-optic modulator, an Acousto-Optic Modulator (AOM), etc. The pattern and the type of the light valve 50 is not limited by the invention. Regarding the method that the light valve 50 converts the illumination beam LB into the image beam LI, enough instructions and recommendations may be learned from ordinary knowledge of the field for detailed steps and implementation thereof, and details thereof are not repeated. In the embodiment, the number of the light valve 50 is one, for example, the projection apparatus 10 using a single DIMD (1-DMD), though in other embodiments, the number of the light values 50 may be plural, which is not limited by the invention.

The projection lens 60, for example, includes one optical lens or a combination of a plurality of optical lenses with refractive power, for example, various combinations of non-planar lenses such as a biconcave lens, a biconvex lens, a concavo-convex lens, a convexo-concave lens, a plano-convex lens, a plano-concave lens, etc. In an embodiment, the projection lens 60 may include a planar optical lens to project the image beam LI coming from the light valve 50 to the projection target in a reflective or transmissive manner. The pattern and type of the projection lens 60 of are not limited by the invention.

Moreover, in some embodiments, the projection apparatus 10 may also selectively include optical elements with a light converging function, a refraction function and a reflection function to guide the illumination beam LB emitted by the illumination system 100 to the light valve 50, and guide the image beam LI generated by the light valve 50 to the projection lens 60, so as to produce the projection beam LP, though the invention is not limited thereto.

The illumination system 100 includes at least one light source 105, a composite phase conversion element 130 and a light uniforming element 140. To be specific, the illumination system 100 further includes a wavelength conversion element 150, at least one light splitting element 160, at least one reflection element 170 and a filter device 180.

The light source 105 is configured to provide at least one beam L. In detail, the light source 105 includes an excitation light source 110 and an auxiliary light source 120, where the excitation light source 110 provides an excitation beam L1, and the auxiliary light source 120 provides an auxiliary beam L2. In the embodiment, the excitation light source 110 is a laser Diode (LD) or a plurality of laser diodes adapted to emit a blue laser beam, and the auxiliary light source 120 is a laser diode or a plurality of laser diodes adapted to emit a red laser beam or a Light-Emitting Diode (LED) adapted to emit a red beam. In other words, in the embodiment, the light source 105 is a laser light-emitting device.

The wavelength conversion element 150 is disposed on a transmission path of the excitation beam L1, and is located between the excitation light source 110 and the light uniforming element 140. The wavelength conversion element 150 has at least one wavelength conversion material to convert the excitation beam L1 into an excited beam L3. In the embodiment, the blue excitation beam is, for example, converted into a green excited beam or a yellow excited beam or a yellow excited green beam. In different embodiments, configuration of the wavelength conversion material of the wavelength conversion element 150 may be changed according to different types of the illumination system 100, and the configuration pattern and type of the wavelength conversion element 150 are not limited by the invention.

The at least one light splitting element 160 is disposed on a transmission path of the excitation beam L1 and/or the auxiliary beam L2, and the at least one reflection element 170 is configured to reflect or transmit the above beam. For example, in the embodiment, the at least one light splitting element 160 includes a Dichroic Mirror used to reflect the blue beam (DMB) and a Dichroic Mirror used to reflect the green and orange beams (DMGO), where the DMB (the light splitting element 160) is located between the auxiliary light source 120 and the composite phase conversion element 130, and is configured to reflect the excitation beam L1 passing through the wavelength conversion element 150 and allows the auxiliary beam L2 coming from the auxiliary light source 120 to pass through. The DMGO (the light splitting element 160) is located between the filter device 180 and the composite phase conversion element 130, and is configured to reflect the excited beam L3 and allows the excitation beam L1 and the auxiliary beam L2 to pass through, such that all of the required beams are converged to the filter device 180. In different embodiments, the configuration of and type the light splitting element 160 and the reflection element 170 may be changed along with different types of the illumination system 100, and the configuration pattern and the type of the light splitting element 160 and the reflection element 170 are not limited by the invention.

The filter device 180 is disposed between the excitation light source 110 and the light uniforming element 140, i.e. located between the DMGO (the light splitting element 160) and the light uniforming element 140, and the filter device 180 has filters of different colors, and the auxiliary beam L2 and the excited beam L3 pass through the filters of different colors to correspondingly generate a red beam part and a green beam part of the illumination beam LB. The filter device 180 has a diffuser or a transparent region to let the excitation beam L1 to pass through to correspondingly generate a blue beam part of the illumination beam LB. To be specific, in the embodiment, the filter device 180 may be a rotatable color filter wheel, and is used for producing a diffusing and/or filtering effect to the excitation beam L1, the auxiliary beam L2 or the excited beam L3 based on timing, such that color purity of the beams passing through the filter device 180 is increased. In different embodiments, configuration of filters of different colors in the filter device 180 may be changed along with different types of the illumination system 100, and the configuration pattern and the type of the filter device 180 are not limited by the invention.

The light uniforming element 140 allows a part of the at least one excitation beam L1 to pass through to form the blue beam part of the illumination beam LB. Namely, the light uniforming element 140 is disposed on a transmission path of the excitation beam L1, the auxiliary beam L2 and the excited beam L3 to adjust shapes of light spots of the above beams, so that a shape of a light spot of the illumination beam LB emitted out from the light uniforming element 140 may matches with a shape (for example, a rectangle) of a working area of the light valve 50, and the light spot have uniform light intensity or all points of the light spot have close light intensity. In the embodiment, the light uniforming element 140 is, for example, an integration rod, though in other embodiments, the light uniforming element 140 may also be other proper types of optical element, which is not limited by the invention.

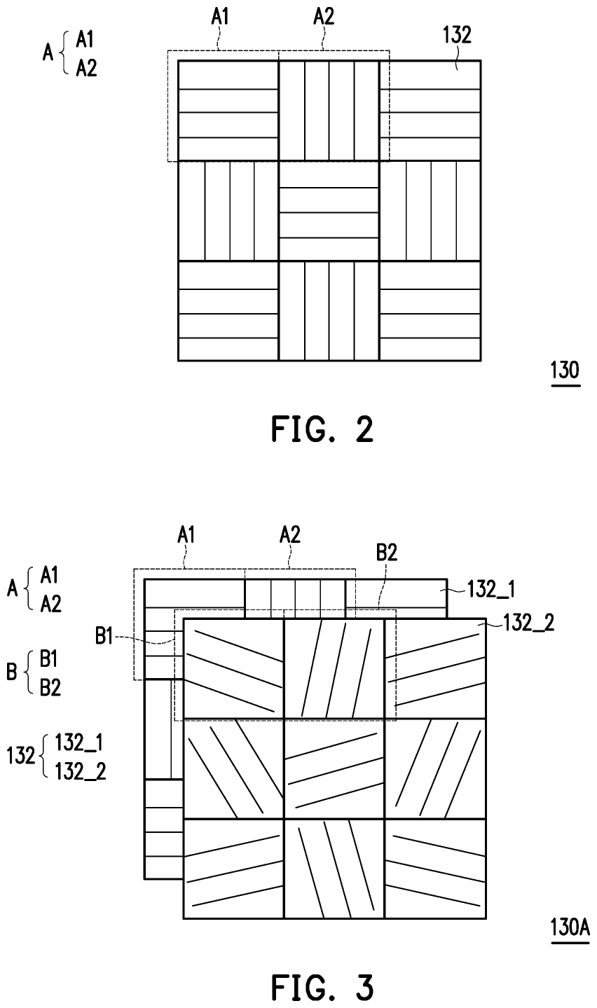

FIG. 2 is a schematic diagram of the composite phase conversion element of FIG. 1. Referring to FIG. 1 and FIG. 2, the composite phase conversion element 130 is disposed on the transmission path of the beam L, and includes at least one polarizing element 132, and the polarizing element 132 is, for example, a one-half wave plate, a quarter wave plate, a depolarizer, a circular polarizer or a combination of the quarter wave plate and a linear polarizer. In the embodiment, the number of the polarizing element 132 is one, and is made of one of the above materials, though the invention is not limited thereto.

In detail, in the embodiment, the polarizing element 132 includes a plurality of polarizing regions A on a same plane, where at least two of the polarizing regions A have different polarization directions, so that the beam L simultaneously penetrates through at least two of the polarizing regions A of the polarizing element 132 to respectively form at least two sub-beam (not shown), and polarization states of the two sub-beams correspond to the polarization directions of the two polarizing regions A penetrated by the two sub-beams. For example, in the embodiment, if the polarizing element 132 is made of the one-half wave plate, and the polarization directions of the polarizing regions A1 and A2 are different, an included angle of two optical axes corresponding to the polarization directions of the adjacent polarizing regions A1 and A2 is 45 degrees (i.e. to form the sub-beams with different polarization states). Therefore, when the excitation beam L1 or the auxiliary beam L2 are transmitted to pass through the polarizing element 132, the excited beam L1 or the auxiliary beam L2 with a composite polarization direction (including the polarization directions of the polarizing regions A1 and A2) are produced, i.e. the polarization states of the two sub-beams passing through the polarizing regions A1 and A2 are directions perpendicular to each other. In some embodiments, the polarizing element 132 may further include at least one transparent region (not shown), the transparent region of the polarizing element 132 may be a hollowed region or configured with transparent glass for letting the beam L to pass through without changing the polarization state, though the invention is not limited thereto.

In other words, since the excitation beam L1 is polarized light (linearly polarized), the excitation beam L1 passing through the polarizing element 132 changes the polarization state thereof due to the type of the polarizing element 132. Therefore, when the excitation beam L1 simultaneously penetrates through the different polarizing regions A of the polarizing element 132, the excitation beam L1 penetrating through the polarizing element 132 has different polarization states at different positions. Namely, when the illumination system 100 operates, the excitation beam L1 may produce outputting light having different polarization directions through the composite phase conversion element 130, and the light intensities of the outputting light are the same, so that the human eyes may feel images with uniform intensity and no specific polarization direction. In this way, when two projection apparatuses 10 are in the polarization 3D mode (i.e. polarizers are externally added to the projection lenses 60, or the polarizers are built in the two projection apparatuses 10), the beams passing through the composite phase conversion elements 130 in the two projection apparatuses 10 again penetrate through the projection lenses 60 and the polarizers to form an image with uniform color and brightness on the screen, such that the user may view a 3D display image with good uniformity through the polarized 3D glasses. Moreover, in the embodiment, the composite phase conversion element 130 is unnecessary to use a motor, which further saves a space and reduce power consumption. Similarly, the aforementioned auxiliary beam L2 or other beams transmitted to the composite phase conversion element 130 may also have the same effect, which is not repeated.

In the embodiment, a manufacturing method of the composite phase conversion element 130 may be as follows. A cutting process is performed to a single polarizing material to generate a plurality of sub-polarizing materials having the same sizes with that of the aforementioned polarizing regions A. Then, the cutted sub-polarizing materials are spliced into the polarizing element 132. In the above cutting step, it may be selected to perform the cutting process in the same direction for each of the sub-polarizing materials, so as to obtain the polarizing regions A with parallel or perpendicular polarization directions, as that shown in FIG. 2. Alternatively, in the above cutting step, it may be selected to perform the cutting process in different directions for each of the sub-polarizing materials, so as to obtain the polarizing regions B1 and B2 with different polarization directions, for example, one of the polarizing elements 132_2 in FIG. 3, the polarizing element 132_2 has a plurality of polarizing regions B, where the polarization directions of the polarizing regions B1 and B2 include an angle there between. In the aforementioned cutting step, squares shown in FIG. 2 and FIG. 3 may be cut out, or other types of geometric figures may be cut out, for example, triangles or hexagons, which is not limited by the invention.

In another embodiment, the composite phase conversion element 130 may further includes an oscillation element (not shown) used for oscillating the polarizing element 132 back and forth along a symmetrical axis, so that the transmission path of the beam L passing there through is changed through the oscillation of the polarizing element 132. Therefore, an effect of enhancing image resolution is achieved by properly shifting the transmission path of the beam L.

FIG. 3 is a schematic diagram of a composite phase conversion element according to another embodiment of the invention. Referring to FIG. 3, the composite phase conversion element 130A of the embodiment is similar to the composite phase conversion element 130 of FIG. 2, and differences there between is that in the embodiment, the number of the polarizing elements 132 is two, and the polarizing elements 132 are misaligned in the transmission direction of the beam L. To be specific, the polarizing elements 132 of the composite phase conversion element 130 include a first polarizing element 132_1 and a second polarizing element 132_2, and the first polarizing element 132_1 and the second polarizing element 132_2 are made of the same polarizing materials, and a plurality of polarizing regions A of the first polarizing element 132_1 and a plurality of polarizing regions B of the second polarizing element 132_2 are configured in misalignment. However, in some embodiments, the first polarizing element 132_1 and the second polarizing element 132_2 may be made of different polarizing materials, though the invention is not limited thereto. In this way, polarization uniformity of the excitation beam L1 or the auxiliary beam L2 is improved, and in application of the polarized 3D mode, the image with uniform color and brightness may be produced on the screen, and the user may observe the 3D display image with good uniformity through the polarized 3D glasses.

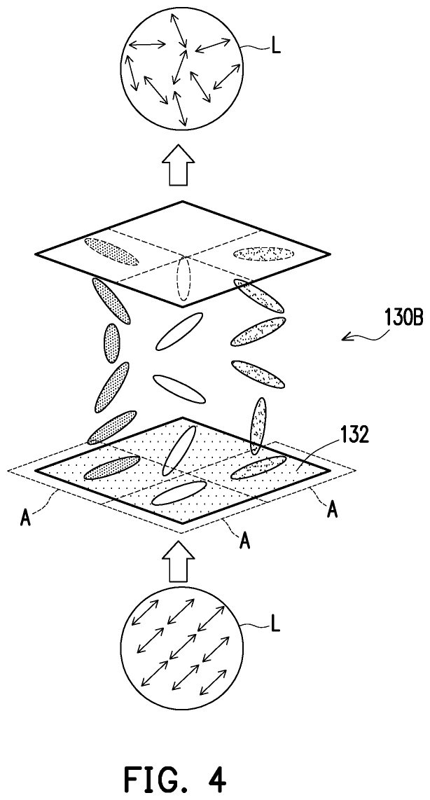

FIG. 4 is a schematic diagram of a composite phase conversion element according to still another embodiment of the invention. In the embodiment, the polarizing element 132 of the composite phase conversion element 130B is a liquid crystal element, and the polarizing element 132 has a plurality of polarizing regions A, and each of the polarizing regions A is a unit with liquid crystal. These polarizing regions A may be respectively input with different currents, or may be sequentially input with different currents, so as to change the polarization state of the beam L penetrating through the polarizing regions A. In detail, in the embodiment, the polarizing element 132 may be input with different currents to change an angle of the polarization direction of the beam L passing there through, and the changed angle of the polarization direction of the beam L is determined according to a magnitude of the current input to the polarizing element 132. Therefore, under a same time, the polarizing element 132 may correspondingly change the angle of the polarization direction of the beam L passing there through based on the plurality of polarizing regions A input with different currents, such that the polarization state of each of the beams L passing there through is different. In this way, in application of the polarized 3D mode, the image with uniform color and brightness may be produced on the screen, and the user may observe the 3D display image with good uniformity through the polarized 3D glasses.

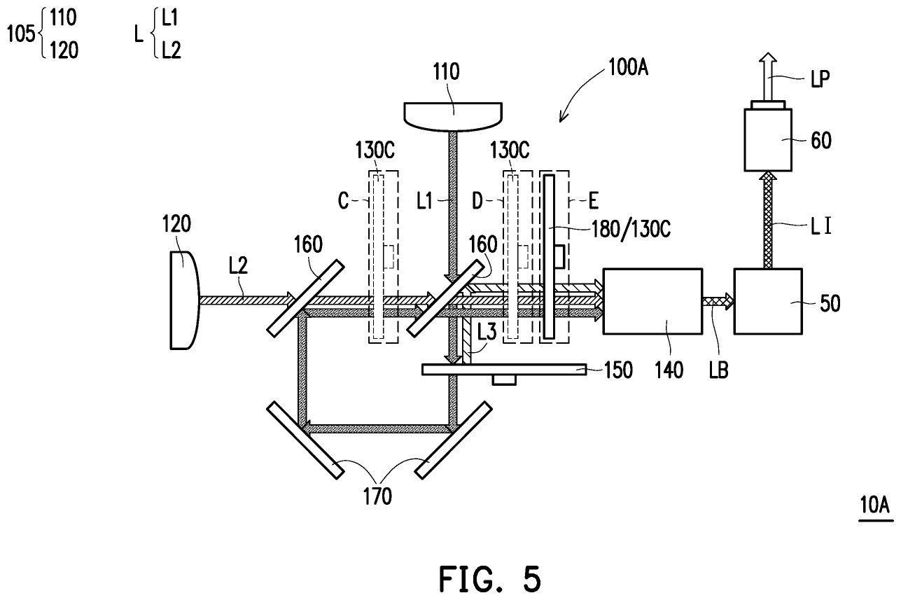

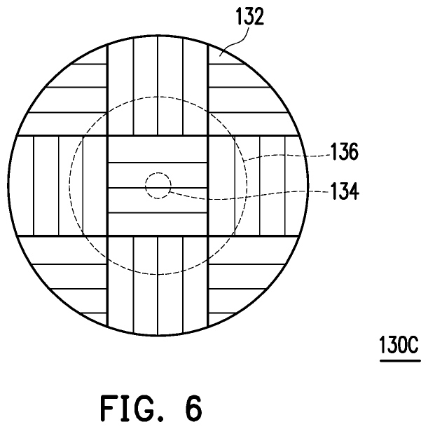

FIG. 5 is a schematic diagram of a projection apparatus according to another embodiment of the invention. FIG. 6 is a schematic diagram of the composite phase conversion element of FIG. 5. Referring to FIG. 5 and FIG. 6, the composite phase conversion element 130C of the projection apparatus 10A of the embodiment is similar to the composite phase conversion element 130 of FIG. 2, and a difference there between is that in the embodiment, the composite phase conversion element 130C is a rotatable optical element. In detail, the composite phase conversion element 130C further includes a rotation shaft 134 and a driving element 136. The polarizing element 132 is connected to the rotation shaft 134, the driving element 136 is configured to drive the rotation shaft 134 to rotate, and the polarizing element 132 may be round disk-like. The driving element 136 is configured to drive the polarizing element 132 to time-sequentially rotate while taking the rotation shaft 134 as a rotation central axis, and when the polarizing element 132 is rotated, the rotation state of the beam L penetrating through the polarizing element 132 is varied along with time. In the embodiment, the driving element 136 is, for example, a motor, which is connected to the rotation shaft 134, and the beam L penetrates through a non-center portion of the polarizing element 132. However, in some embodiments, the driving element 136 is, for example, a driving assembly, and the beam L penetrates through a center portion of the polarizing element 132, which is not limited by the invention. In this way, the polarization evenness of the excitation beam L1 or the auxiliary beam L2 is further improved, and in application of the polarized 3D mode, the image with uniform color and brightness may be produced on the screen, and the user may observe the 3D display image with good uniformity through the polarized 3D glasses.

It should be noted that the composite phase conversion element 130C may be selectively disposed at a plurality of different positions of the illumination system 100A or the projection apparatus 10A. In detail, the composite phase conversion element 130C may be disposed between the auxiliary light source 120 and the wavelength conversion element 150, further, the composite phase conversion element 130C is located between the DMGO (the light splitting element 160) and the auxiliary light source 120, for example, a position C shown in FIG. 5. In this way, the excitation beam L1 passing through the wavelength conversion element 150 and the auxiliary beam L2 emitted by the auxiliary light source 120 may pass through the composite phase conversion element 130C, such that the polarization states of the excitation beam L1 and the auxiliary beam L2 may be uniform in timing to achieve a good display effect. However, in a different embodiment, the composite phase conversion element 130C may also be disposed between the wavelength conversion element 150 and the filter device 180. Further, the composite phase conversion element 130C is located between the DMGO (the light splitting element 160) and the filter device 180, for example, a position D shown in FIG. 5, so that the excitation beam L1, the auxiliary beam L2 and the excited beam L3 may pass through the composite phase conversion element 130C. In another different embodiment, the projection apparatus 10A may not include the filter device 180, and the composite phase conversion element 130C may include a filter element (not shown), where configuration positions of the filter element and the polarizing element 132 are coincided, i.e. the composite phase conversion element 130C is disposed on the filter element. In other words, the composite phase conversion element 130C is combined with the color filter element to form a filter device, for example, a position E shown in FIG. 5.

Besides, it should be noted that in some embodiments, the number of the polarizing element 132 of the composite phase conversion element 130C of FIG. 5 may be increased to two, so as to form the composite phase conversion element 130C similar to that of FIG. 3. In the embodiment, one of the two polarizing elements 132 (132_1, 132_2) may be further controlled to time-sequentially rotate in a direction parallel to the transmission direction of the beam L, i.e. one of the polarizing elements 132 is stationary and does not rotate. Alternatively, the two polarizing elements 132 are controlled to time-sequentially rotate in the direction parallel to the transmission direction of the beam L, and rotation speeds of the two polarizing elements 132 are different, i.e. the two polarizing elements 132 are all rotated but the rotation speeds thereof are different. It should be noted that the situation that the polarizing assembly is time-sequentially rotated in the direction parallel to the transmission direction of the beam L is that the polarizing assembly is time-sequentially rotated while taking the direction parallel to the transmission direction of the beam L as a rotation axis. Therefore, in application of the polarized 3D mode of the projection apparatus, the image with uniform color and brightness may be produced on the screen, and the user may observe the 3D display image with good uniformity through the polarized 3D glasses.

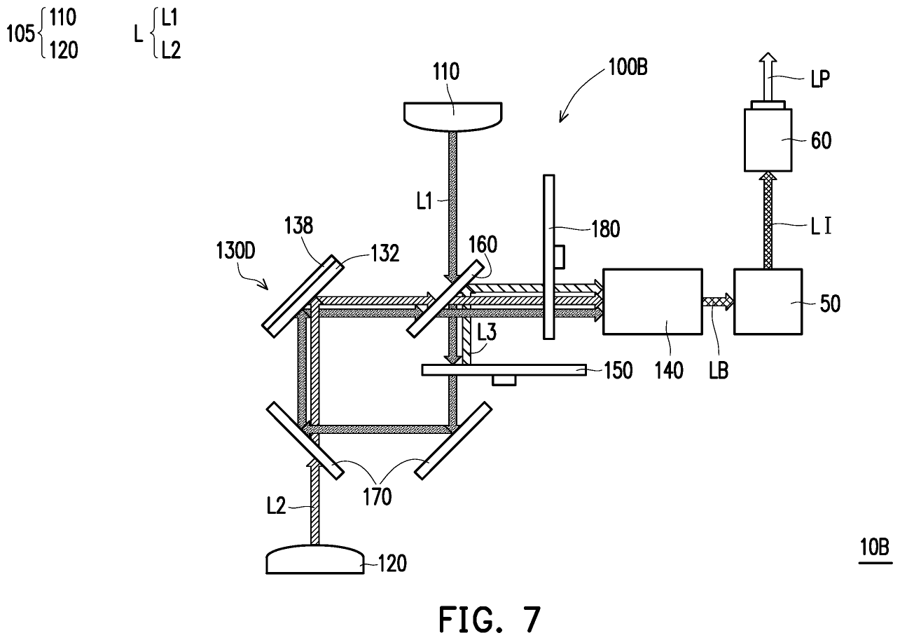

FIG. 7 is a schematic diagram of a projection apparatus according to another embodiment of the invention. Referring to FIG. 7, the composite phase conversion element 130D of the embodiment is similar to the composite phase conversion element 130 of FIG. 1, and a difference there between is that in the embodiment, the composite phase conversion element 130D is a reflective optical element. In detail, in the embodiment, the composite phase conversion element 130D further includes a reflector 138 disposed on the polarizing element 132 for reflecting a sub-beam penetrating through the polarizing element 132. In detail, the composite phase conversion element 130D is located between the DMGO (the light splitting element 160) and the auxiliary light source 120, and after the excitation beam L1 coming from the wavelength conversion element 150 and the auxiliary beam L2 coming from the auxiliary light source 120 penetrate through the polarizing element 132, the excitation beam L1 and the auxiliary beam L2 are reflected to the DMGO (the light splitting element 160) by the reflector 138, such that the polarization states of the excitation beam L1 and the auxiliary beam L2 are even in timing. Therefore, an occupation volume of the projection apparatus 10B may be further reduced, and the user may observe the 3D display image with good uniformity through the polarized 3D glasses.

In summary, the embodiments of the invention have at least one of following advantages or effects. In the composite phase conversion element of the invention or the projection apparatus configured with the composite phase conversion element, the polarizing element includes a plurality of polarizing regions on the same plane, and at least two of the polarizing regions have different polarizing directions. Therefore, the beam may penetrate through the polarizing element, and the beam penetrating through the polarizing element has different polarization states at different positions. In this way, in the polarization 3D mode of the projection apparatus (i.e. the polarizer is externally added to the projection lens), the color or the brightness of the display image may be uniform, so that the user may observe the 3D display image with better uniformity through a pair of polarized 3D glasses.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A composite phase conversion element, disposed on a transmission path of at least one beam, and comprising:
at least one polarizing element, comprising a plurality of polarizing regions on a same plane, wherein at least two of the polarizing regions have different polarization directions, the at least one beam simultaneously penetrates through at least two of the polarizing regions of the at least one polarizing element to respectively form at least two sub-beams, and polarization states of the at least two sub-beams correspond to the polarization directions of the at least two of the polarizing regions penetrated by the at least two sub-beams.

2. The composite phase conversion element as claimed in claim 1, wherein the at least one polarizing element is made of a same polarizing material.

3. The composite phase conversion element as claimed in claim 2, wherein the at least one polarizing element is a one-half wave plate, a quarter wave plate, a depolarizer, a circular polarizer, a liquid crystal element or a combination of the quarter wave plate and a linear polarizer.

4. The composite phase conversion element as claimed in claim 1, wherein the at least one polarizing element further comprises at least one transparent region to let the at least one beam to pass through.

5. The composite phase conversion element as claimed in claim 1, further comprising:
a rotation shaft, connected to the at least one polarizing element; and
a driving element, configured to drive the rotation shaft to rotate, wherein the driving element is configured to drive the at least one polarizing element to time-sequentially rotate while taking the rotation shaft as a rotation central axis, and when the at least one polarizing element is rotated, the polarization state of the at least one beam penetrating through the polarizing element is varied along with time.

6. The composite phase conversion element as claimed in claim 5, wherein the driving element is a motor, and is connected to the rotation shaft, and the at least one beam penetrates through a non-center portion of the at least one polarizing element.

7. The composite phase conversion element as claimed in claim 5, wherein the driving element is a driving assembly, and the at least one beam penetrates through a center portion of the at least one polarizing element.

8. The composite phase conversion element as claimed in claim 1, further comprising:
a reflector, disposed on the at least one polarizing element, and configured to reflect a plurality of the sub-beams penetrating through the at least one polarizing element.

9. The composite phase conversion element as claimed in claim 8, further comprising:
an oscillation element, configured to oscillate the at least one polarizing element back and forth along a symmetrical axis.

10. The composite phase conversion element as claimed in claim 1, wherein the number of the at least one polarizing element is two, and the two polarizing elements are misaligned in a transmission direction of the at least one beam.

11. The composite phase conversion element as claimed in claim 10, wherein one of the two polarizing elements is time-sequentially rotated in a direction parallel to the transmission direction of the at least one beam.

12. The composite phase conversion element as claimed in claim 10, wherein the two polarizing elements are time-sequentially rotated in a direction parallel to the transmission direction of the at least one beam, and rotation speeds of the two polarizing elements are different.

13. A projection apparatus, comprising:
an illumination system, adapted to provide an illumination beam, and comprising:
at least one light source, configured to provide at least one beam; and
a composite phase conversion element, disposed on a transmission path of the at least one beam, and comprising:
at least one polarizing element, and comprising a plurality of polarizing regions on a same plane, wherein at least two of the polarizing regions have different polarization directions, the at least one beam simultaneously penetrates through at least two of the polarizing regions of the at least one polarizing element to respectively form at least two sub-beams, and polarization states of the at least two sub-beams correspond to the polarization directions of the at least two of the polarizing regions penetrated by the at least two sub-beams, and the illumination beam comprises the at least two sub-beams;
at least one light valve, disposed on a transmission path of the illumination beam, and configured to convert the illumination beam into an image beam; and
a lens, disposed on a transmission path of the image beam, and is configured to convert the image beam into a projection beam.

14. The projection apparatus as claimed in claim 13, wherein the at least one polarizing element is made of a same polarizing material.

15. The projection apparatus as claimed in claim 14, wherein the at least one polarizing element is a one-half wave plate, a quarter wave plate, a depolarizer, a circular polarizer, a liquid crystal element or a combination of the quarter wave plate and a linear polarizer.

16. The projection apparatus as claimed in claim 13, wherein the at least one polarizing element further comprises at least one transparent region to let the at least one beam to pass through.

17. The projection apparatus as claimed in claim 13, wherein the composite phase conversion element further comprises a rotation shaft and a driving element, the rotation shaft is connected to the at least one polarizing element, and the driving element is configured to drive the rotation shaft to rotate, wherein the driving element is configured to drive the at least one polarizing element to time-sequentially rotate while taking the rotation shaft as a rotation central axis, and when the at least one polarizing element is rotated, the polarization state of the at least one beam penetrating through the polarizing element is varied along with time.

18. The projection apparatus as claimed in claim 17, wherein the driving element is a motor, and is connected to the rotation shaft, and the at least one beam penetrates through a non-center portion of the at least one polarizing element.

19. The projection apparatus as claimed in claim 17, wherein the driving element is a driving assembly, and the at least one beam penetrates through a center portion of the at least one polarizing element.

20. The projection apparatus as claimed in claim 13, wherein the composite phase conversion element further comprises a reflector disposed on the at least one polarizing element and configured to reflect a plurality of the sub-beams penetrating through the at least one polarizing element.

21. The projection apparatus as claimed in claim 20, wherein the composite phase conversion element further comprises an oscillation element configured to oscillate the at least one polarizing element back and forth along a symmetrical axis.

22. The projection apparatus as claimed in claim 13, wherein the number of the at least one polarizing element is two, and the two polarizing elements are misaligned in a transmission direction of the at least one beam.

23. The projection apparatus as claimed in claim 22, wherein one of the two polarizing elements is time-sequentially rotated in a direction parallel to the transmission direction of the at least one beam.

24. The projection apparatus as claimed in claim 22, wherein the two polarizing elements are time-sequentially rotated in a direction parallel to the transmission direction of the at least one beam, and rotation speeds of the two polarizing elements are different.
